(19) United States
(12) Patent Application Publication
(10) Pub. No.: US 2007/0140225 A1
(43) Pub. Date: Jun. 21, 2007

(54) Enhancing Cellular Telephone Capabilities Using a Multi-Channel Network

(75) Inventors: Martin Frid-Nielsen, Menlo Park, CA (US); steven Ray Boye, Vaerloese (DK); Simun Jacobsen, Niva (DK)

Correspondence Address: HAYNES BEFFEL & WOLFELD LLP, P O BOX 366, HALF MOON BAY, CA, 94019, US

(73) Assignee: SOONER, Menlo Park, CA (US)

(21) Appl. No.: 11/548,243

(22) Filed: Oct. 10, 2006

Related U.S. Application Data
(60) Provisional application No. 60/752,807, filed on Dec. 21, 2005.
(60) Provisional application No. 60/765,880, filed on Feb. 7, 2006.

(51) Int. Cl. H04L 12/66

(52) U.S. Cl. 370/352

(57) ABSTRACT

A method for efficient communication from a cellular telephone handset. The method begins with the step of providing a cellular telephone handset, including an interface to a computer software system for requesting a call and providing a desired call number. Then, the system sends a message from the handset to a base computer, requesting a call and specifying a desired telephone number. The base computer receives the message and generates a conference call request to a telephone network provider, specifying the numbers of the handset and the desired telephone number. The telephone network conducts a conference call via the telephone network between the handset and the desired number.

### RELATED APPLICATION

This application claims the benefit of U.S. Provisional Patent Application No. 60/752,807, entitled “Method and System for Efficient Use of Cellular Telephones” filed on 21 Dec. 2005 by Martin Frid-Nielsen, and U.S. Provisional Patent Application No. 60/765,880, entitled “Method and System for Expanding the Efficient Use of Cellular Telephones” filed on 7 Feb. 2006 by Martin Frid-Nielsen. Those applications are incorporated by reference for all purposes.

### BACKGROUND OF THE INVENTION

The present invention relates to network communications. In particular, it relates to interfacing cellular telephony to voice over IP telephony networks.

The growing use and acceptance of internet-based telephony, also referred to as Voice over IP (VOIP) telephony, is having a strong effect on voice communication systems. As the reliability and quality of telephone systems converge with those of traditional landline systems, the marked cost advantages of telephone exert strong pressure for adoption of that technology. The result is explosive growth in the telephone sector, especially for commercial applications requiring frequent international calling.

At the same time, cellular telephone has become completely ubiquitous. Cellular telephone use is largely assumed in many businesses and situations, and the expansion of coverage areas has led to increasing adoption by casual users, who use cellular telephones in preference to landline, rather than the business users who formerly made up the bulk of subscribers.

The basic nature of telephone, however, makes it inherently difficult for a cellular telephone user to gain access to that service. As the name suggests, telephone requires a connection that communicates over a network, using IP (Internet Protocol) as the transmission means. Broadly speaking, IP involves breaking a message into packets and sending packets into a network, without establishing a set path between the sender and receiver. Each packet includes information about its destination, origin and position in the message. Individual packets may travel different paths to the destination, where the message is assembled by arranging packets in the correct order.

Conventional telephone communication requires that a circuit be established between sender and receiver, and that circuit remains open during the entire communication. Cellular telephony operates the same way, with a radio link between the cellular telephone handset and a transceiver tower substituting for the first link in the landline chain.

A landline telephone can function on a telephone network by feeding its signal through a computer having appropriate modem and processing software installed. From the computer, the signal employs the computer's internet connection to place and conduct the call. A cellular telephone clearly cannot avail itself of that technique, as it is hardwired into the conventional telephone system.

Thus, the art awaits a method for employing cellular telephones to access telephone networks.

### SUMMARY OF THE INVENTION

An aspect of the invention is a method for efficient communication from a cellular telephone handset. The method begins with the step of providing a cellular telephone handset, including an interface to a computer software system for requesting a call and providing a desired call number. Then, the system sends a message from the handset to a base computer, requesting a call and specifying a desired telephone number. The base computer receives the message and generates a conference call request to a telephone network provider, specifying the numbers of the handset and the desired telephone number. The telephone network conducts a conference call via the telephone network between the handset and the desired number.

### BRIEF DESCRIPTION OF THE DRAWINGS

FIG. 1 is a schematic illustration of a system for accessing a telephone network from a cellular telephone.

FIG. 2 is a schematic illustration of a system for accessing a telephone network from a cellular telephone, depicting a special case scenario.

FIG. 3 is a schematic illustration of a system for presenting audio content to a cellular telephone user.

FIG. 4 is a flowchart illustrating an embodiment of the process claimed herein.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

The structure, utility and advantages of a multi-channel network are presented in three previous US patent applications, entitled “Method for Distributing Data, Adapted for Mobile Devices,” U.S. Ser. No. 11/238,838, filed Sep. 29, 2005; “Network Adapted for Mobile Devices,” U.S. Ser. No. 11/238,839, filed Sep. 29, 2005; and “Virtual Publication of Data, Adapted for Mobile Devices,” U.S. Ser. No. 11/238,669, filed Sep. 29, 2005. These applications are hereby incorporated by reference for all purposes.

As used herein, the term “multi-channel network” refers to a network structure described in the patent applications described in the preceding paragraph.

While the method set out in the claims is particularly desirable when practiced in conjunction with a telephone network, the method can also be employed on a conventional telephone (POTS) network. Indeed, in some situations, a POTS network could be a superior choice. Therefore, the term “telephone network” is used herein to denote the transmission means employed. That term should be read as encompassing all types of telephone networks, specifically including VOIP systems. As is known in the art, POTS and VOIP systems interoperate seamlessly, and thus the choice of system for a given application can be based on factors such as cost and system availability.

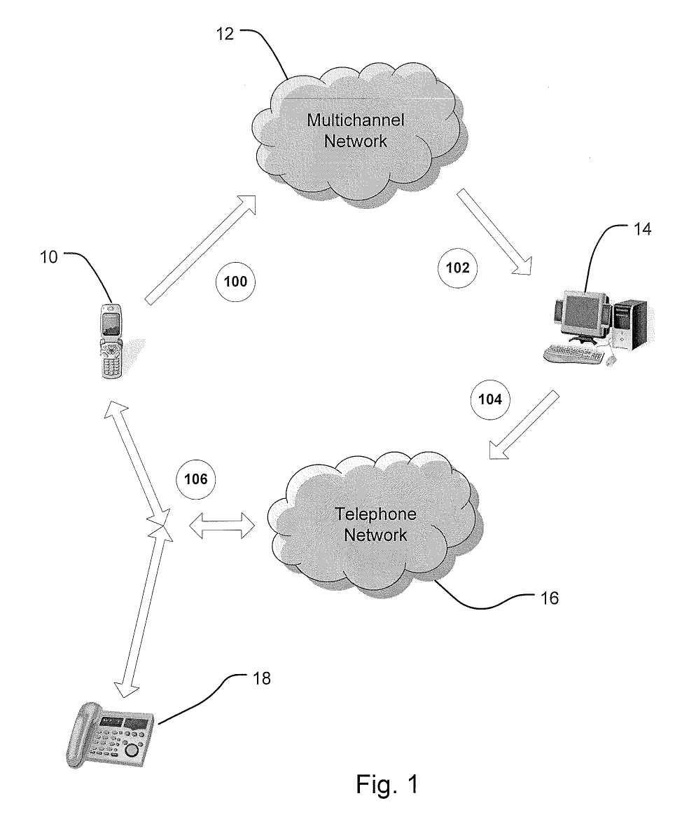

An embodiment of a method for accessing a telephone network employing a cellular telephone is shown in FIG. 1. As shown, a cellular telephone handset 10 is available for use by a first user, and a second user has a landline unit 18 at her disposal. It would be possible for the first user to initiate a conventional cellular telephone call, of course, but in many situations that course of action is prohibitively expensive. If the two units are not in the same calling area, for example, the conventional rate structure could be many times above the rate that would be possible if the call could be make using a telephone network. The rate difference can be extreme if, for example, the two units are in different countries, not simply different area codes. Then the rate schedule could be such that using a cellular telephone would not be justified for any use short of an emergency. It is typical in the art that cellular telephone users are subject to a calling plan, which sets out pricing based on time expended and areas called, as well as the area in which the unit is used. Making an international call, for example, may or may not be allowed under a given plan. The remainder of this application assumes such issues are not relevant to any of the material at hand.

Remaining elements in this embodiment are the multi-channel network 12, the cellular telephone user's base computer 14, and a selected telephone network 16. The term “base” computer means a computer having a broadband connection to the internet, most usually a home or office computer. It should be understood, however, that the steady increases in capability and decreases in size indicate that the term “base” cannot be limited to a home or office computer, or even to a desktop device. At the time of the filing of this application, a laptop device will be completely capable of serving as a “base” computer as that term is used here. No other limitations should be read into that term.

To initiate a call, the handset user makes contact with the base computer 14, shown as steps 100 and 102. In one embodiment, that connection is established via the multi-channel network 12, at step 100. The user makes contact with the multichannel network via a telephone call over the POTS network. The user transmits instructions to the multichannel network, which then issues instructions to the base computer. A number of means exist to provide such functionality, such as an automated dial-in system that a user calls, establishing identity by an entry code or password, or both. The system could similarly be set to recognize incoming calls by their caller ID, which then could be supplemented by a password for greater security.

The multi-channel network 12 then executes a call to the base computer, in step 102, preferably employing the internet connection to that computer. In one embodiment the user's instructions to the multichannel network indicate the number of the telephone 18 to be called, either by keying in the number or using preset auto-dial lists. In an alternative embodiment, the user could bypass the multichannel network and place a direct call to the base computer, but that step would only be useful if the cellular telephone and base computer were in the same Local Access Transport Area (LATA), resulting in a no-charge call.

In another embodiment, the multi-channel network automatically identifies the caller, establishes identity with an appropriate password, and accepts the entry of a desired contact number. The multi-channel network establishes contact with the base computer, via that unit's internet connection, as shown in step 102. In the embodiment shown, the multichannel network does not terminate the connection of the data channel between the handset and the multichannel network. Other embodiments could implement such a termination if that were seen as advantageous. A variety of conventional means exists to perform such functions, including systems based on email or internet technology, and any such systems are appropriate here.

The base computer receives the incoming message from the multi-channel network and initiates a communication with the telephone network, step 104. As set out above, contact between the multi-channel network and the base computer can be accomplished by a number of means, preferably employing email or browser technology, both known in the art. In step 404, incoming data from the multi-channel network is accepted. Such data transfer can be accomplished using any of a number of well-known techniques, as is known in the art. The system is configured to parse the message from the multichannel network, in step 406, to determine the call parameters, such as the number to be called, any timing considerations, and the like, after which it launches the system for calling the telephone network, in step 408. That system is preferably contained in a software module installed and resident on the base computer for handling tasks associated with VOIP calling, hereafter referred to as the “telephone system.” It should be noted that the telephone system can incorporate a time delay between the communication from the network and the action of placing a call, thus ensuring that a rapid callback does not trigger a busy signal. Such a time delay can be stated in terms of a wait period (e.g., instruction to place a call one hour after receipt of instruction from the multichannel network) or an absolute time for the call (place call at 9 AM, on a set date).

In addition, the telephone system proceeds to identify the desired connection number from the information received, in step 410. That can be accomplished, for example, by appropriate location within the input string, or by a code, or similar means known in the art. The telephone system then establishes a connection with the telephone network, in step 412, which in one embodiment occurs employing the internet, and communicates a signal to the telephone network that includes desired communication information. Such information consists, in one embodiment, of at least a command to activate the “conference call” feature of that network, described in more detail below, and the numbers involved, one of which is the number of cellular telephone handset 10. Once that information has been successfully communicated, the base computer disconnects from the telephone system, in step 416.

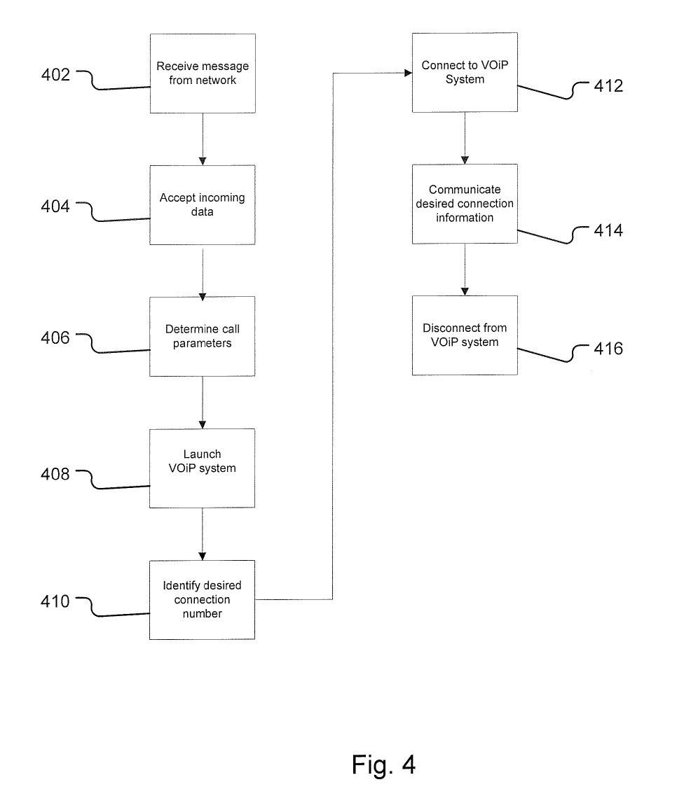

A common feature of telephone networks is a “conference call” facility, by which the network can establish a connection between two selected telephone receivers. That process should be contrasted with the “normal” sequence of a call, by which one telephone user calls another. Here, a system subscriber may schedule a call between two or more receivers, and the system will proceed to establish the requested connection, either then or at some future time. Because telephone networks are generally accessed directly from a computer, rather than via conventional telephone keypads, such networks are highly amenable to automated command as suggested herein. Thus, the communication from the base computer to the telephone network in step 104, FIG. 1, or step 414, FIG. 4, contains appropriate coding to direct the telephone network to establish a connection, the numbers to be connected, and the time of connection. For a call of the sort generally contemplated here, the time will be the present, but other times can be selected and provided for easily.

The telephone network proceeds to establish the desired connection in step 106. As shown, the network establishes a direct connection between cellular telephone handset 10 and another telephone receiver 18. Although the receiver 18 is depicted as a fixed receiver location, it will be understood that this device can be any telephone receiver, including another cellular telephone, or a user employing a computer and appropriate voice interface devices (such as a speaker and microphone, or a headset device. The important point is that the connection between the two devices is achieved and maintained at a cost rate that is far more desirable than any conventional connection.

It should be noted that the connection established by this embodiment takes full advantage of VOIP technology to provide call connections at the lowest possible rate, while also providing the convenience of mobile telephony. Any forwarding services provided by prior art systems are made at premium prices, which markedly erode the price advantage that makes VOIP technology attractive.

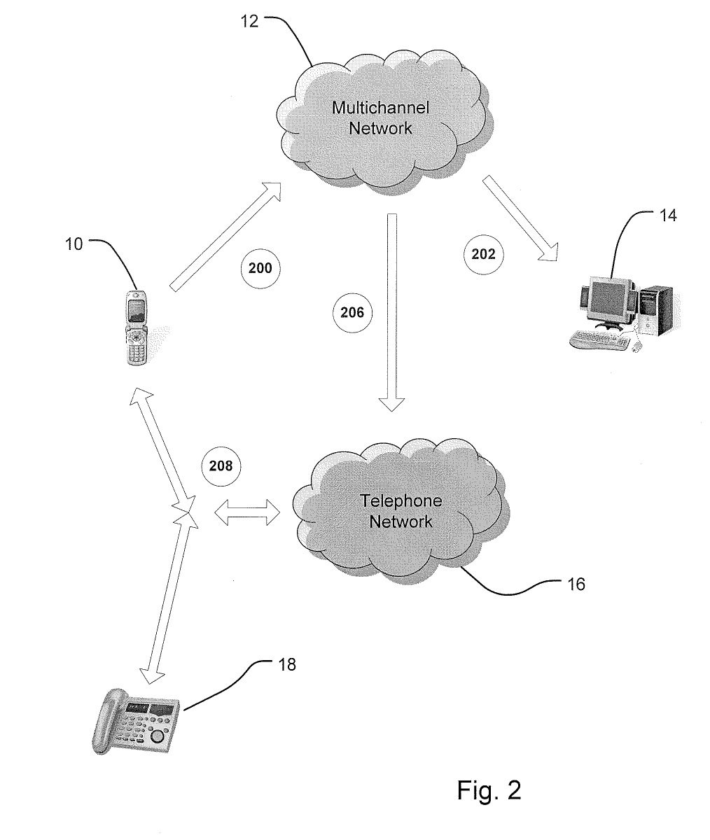

It can be immediately seen, of course, that one key point about the embodiment shown in FIG. 1 is that the base computer must be operating and connected to the internet. An embodiment that eliminates that necessity is shown in FIG. 2, in which the same reference numbers are used to refer to identical components.

There, the actions occurring in steps 200 and 202 are identical to those of steps 100 and 102. That is, the cellular telephone user of handset 10 calls the multi-channel network and communicates the request for a connection and the number of the desired recipient. The multi-channel network checks the status of the base computer, but here that computer is not operational, or the connection to the internet is not available. Here, the multi-channel network is prepared for such an eventuality, and a system is provided for dealing with that situation. The multi-channel network thus places a call directly to the telephone network, in step 206, providing the request for conference call and the numbers to be connected. The telephone network responds by establishing the desired connection, in step 208.

It will be appreciated that the service of communicating with the telephone network is an action that can be performed either by a device directly controlled by the user of the cellular telephone handset 10, as presented in the embodiment depicted in FIG. 1, or by some other entity. Including that service in the package of offerings presented by the multi-channel network 16, as seen in connection with the embodiment shown in FIG. 2, would seem to be a desirable and convenient extension of other services offered there. In addition, that service frees the user from the necessity of ensuring that the base computer is operating at any given time. Additionally, such a service allows a user to operate at a great remove from home base. For example, a user who resides in the United States would appreciate the capability to place calls while traveling in Europe, without requiring the multi-channel network to communicate with a base computer back in, for example, California. Such examples can be multiplied.

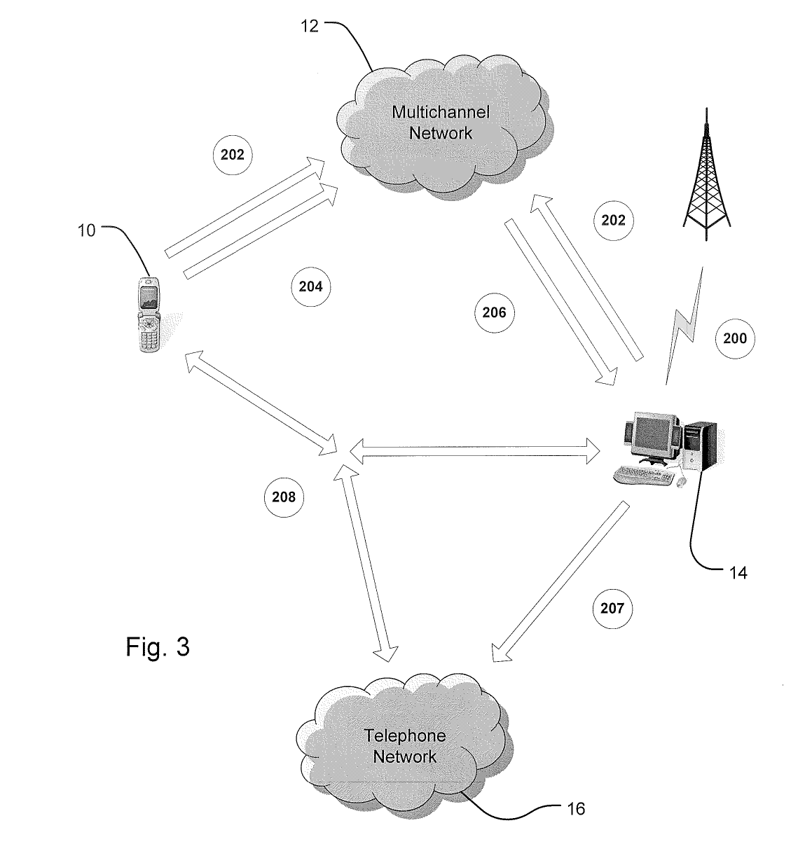

The features of the multi-channel network 16, described in detail in the patent applications incorporated herein, lend themselves to a number of combinations with telephone systems, beyond those described above. One further embodiment is shown in FIG. 3, allowing a cellular telephone user to access recorded material. The embodiments set out above all primarily address the situation in which a user is operating away from a home or office location. In such situations, it would be also advantageous to access material recorded on the base computer. Such material could range from music to recorded audiovisual material to recorded messages. A common feature is that all are media recordings, which tend to be highly bandwidth intensive. Thus, despite the theoretical possibility of downloading such material to the handset 10, that solution is not practical, given the memory and processor capabilities of user devices now and for the near future, if ever. A solution is to be able to listen to such content, but without incurring the high costs that transmitting the material over a telephone connection. Moreover, even if the material could be sent to the handset 10, there likely would not be sufficient space to store very much of such material.

In addition, it is known in the art to provide sources for streaming audio content. Such require sources require considerable bandwidth, as many include relatively high fidelity recorded material. Streaming content of this nature is primarily aimed at users with full computer capability, rather than the limited resources of a handset. Also, the timing of streaming sources is generally set by the provider, rather than being available on demand.

The solution shown in FIG. 3 takes advantage of the capabilities of the multi-channel network. Initially, the user must decide what materials are desirable to record, and must configure the base computer 14 to accomplish that task, as shown in step 200. As generally known, such recordings can be made via a number of channels, including “podcasting”, defined in the Wikipedia as “Podcasting is the method of distributing multimedia files, such as audio programs or music videos, over the internet for playback on mobile devices and personal computers. Podcasts are distributed using either the RSS or Atom syndication formats.” Http://en.wikipedia.org/wiki/Podcasting. That is, the user can configure the base computer to record not only media such as music, but various services offered as RSS feeds, such as weather, news or stock market information. In addition, the base computer could be configured to record telephone messages or the like. Literally any files that can be rendered as audio content are suitable for this embodiment.

The user can view the files available for listening by using the capabilities of the multi-channel network, as set out in the materials incorporated herein. As seen in FIG. 3, the user can utilize the multi-channel network 12 to view files on the base computer 14. The user could, of course, simply download or stream those files to the handset 10, as taught in the incorporated materials, but the storage abilities of handsets generally precludes that measure. In addition, the bandwidth required for such a transfer could use significant telephone time, which could be highly expensive. Rather, employing the principles set out herein, the user can listen to the material without downloading it. That is accomplished by first selecting a file, or files, and indicating that choice via the multi-channel network, as shown in step 204. Those in the art will understand that step 204 can be implemented using a number of conventional techniques. In one embodiment, software modules are located at both the multi-channel network and the base computer, and the user launches the modules from a menu that appears on the handset screen. The user selects file(s) in step 204, which choices are relayed to the base computer in step 206.

The module on base computer 14 responds to the message of step 206 by instructing the telephone network 16 to set up a conference call between handset 10 and base computer 14. Here, the conference call will be established not between the handset user and a third party, but rather between the handset user and the base computer, using a standard telephone interface device, such as a modem, as shown.

The telephone network 16 proceeds to set up the conference call in step 208, using the techniques discussed above. Once the call is established, the base computer is configured to respond by running the selected media files. That action can be programmed in a number of ways, as conventional in the art. In one embodiment, the user keys a preset sequence of numbers on the handset keypad, serving as a signal to the computer to begin the media sequence.

The base computer then executes the selected media files, which are transmitted to the handset via the network. A software module provided to the user and installed in the base computer selects the appropriate content file and “plays” it, transmitting the content into the telephone system in the same manner as any audio content, such as speech. In this manner, the user is able to listen to media files without requiring either the use of network bandwidth or handset storage capacity. A user can make use of this capability to listen to existing media files, RSS/Atom feeds gathered by the base computer, or to voice messages.

While the present invention is disclosed by reference to the preferred embodiments and examples detailed above, it is understood that these examples are intended in an illustrative rather than in a limiting sense. It is contemplated that modifications and combinations will readily occur to those skilled in the art, which modifications and combinations will be within the spirit of the invention and the scope of the following claims.

We claim as follows:

1. A method for efficient communication from a cellular telephone handset, comprising the steps of
providing a cellular telephone handset, including an interface to a computer software system for requesting a call and providing a desired call number;
sending a message from the handset to a base computer, requesting a call and specifying a desired telephone number;
receiving the message at a base computer and generating a conference call request to a telephone network provider, specifying the numbers of the handset and the desired telephone number;
conducting a conference call via the telephone network between the handset and the desired number.

2. The method of claim 1, wherein the sending step includes the steps of
transmitting a call request from the handset to a multi-channel network;
making contact with a base computer via the multichannel network.

3. The method of claim 1, wherein the telephone network employs voice over IP telephony.

4. The method of claim 1, wherein the multichannel network verifies user identity by means of caller ID recognition and password entry.

5. A method for efficient communication from a cellular telephone handset, comprising the steps of
providing a cellular telephone handset, including an interface to a computer software system for requesting a call and providing a desired call number;
sending a message from the handset to a base computer, via a multi-channel network, requesting a call and specifying a desired telephone number;
receiving an indication in the multi-channel network that the target computer is not available;
activating backup calling mechanism within the multi-channel network, and thereby generating a conference call request to a telephone network provider, specifying the numbers of the handset and the desired telephone number;
conducting a conference call via the telephone network between the handset and the desired number.

6. The method of claim 5, wherein the telephone network employs voice over IP telephony.

7. The method of claim 5, wherein the multichannel network verifies user identity by means of caller ID recognition and password entry.

8. A method for receiving stored audio content on a cellular telephone handset, comprising the steps of
receiving and storing audio content on a base computer;
providing a cellular telephone handset, including an interface to a computer software system for requesting a call, providing a desired call number, and selecting content stored on the computer;
accessing the directory of the base computer to determine the identify of stored audio content;
sending a message from the handset to the base computer, requesting a call, specifying the modem telephone number of the base computer and identifying stored content;
conducting a conference call via the telephone network between the handset and the base computer, the base computer playing the stored audio content during such call.

9. The method of claim 1, wherein the telephone network employs voice over IP telephony.

10. The method of claim 1, wherein the multichannel network verifies user identity by means of caller ID recognition and password entry.

11. The method of claim 1, wherein receiving and storing audio content includes downloading content files.

12. The method of claim 1, wherein receiving and storing audio content includes receiving streamed content files.

13. The method of claim 1, wherein the request for a conference call includes specifying a time for placing the call.

14. The method of claim 1, wherein conducting the call includes the step of delaying call placement until the time specified by the user for placing the call.
